(19) United States
(12) Patent Application Publication
(10) Pub. No.: US 2004/0043789 A1
(43) Pub. Date: Mar. 4, 2004

(54) Communications system and method for calculating fees for subscriber groups

(76) Inventor: Marcus Gobel, Munich (DE)

Correspondence Address: Rocco S Barrese, Dilworth & Barrese, 333 Earle Ovington Boulevard, Uniondale, NY, 11553, US

(21) Appl. No.: 10/333,567

(22) PCT Filed: Nov. 23, 2001
(86) PCT No.: PCT/EP01/13661

(30) Foreign Application Priority Data
Nov. 23, 2000 (DE) 100 58 064.5

(51) Int. Cl. H04Q 7/20

(52) U.S. Cl. 455/558; 455/560; 455/445

(57) ABSTRACT

The invention relates to a communications system and to a suitable method for operating the communications system. Based on an inventive allocation table, this system creates the possibility of allowing dedicated mobile stations special fee calculation without technical complications or modifications.

This invention relates to a communications system or a method for operating the communications system in accordance with the preamble of claims 1 or 10.

Conventional communications systems or the switching units making the communications systems available—also of the applicant—operate at considerable technical and administrative expense. The technical expense includes the interplay of several technical components of a network which is configured to also administer mobile stations apart from fixed network stations and in such a way that the user always has a functional network at his disposal. Using available standards, for example GSM standards, the attempt is now being made to provide users of mobile stations with optimum conditions of usage or to optimise the requirements of the mobile station user. Based on preset standards however the usage options with respect to the technical expense to be used therefor is expandable to a limited extent only. Nevertheless efforts were made on the switching unit side and thus frequently on the network side, so that the available switching units can offer products which differ from those of competitors. For this purpose the parameters available in a mobile station (MS), such as for example subscriber data module (SIM card) and subscriber identification data (IMSI) deposited thereon as well as corresponding home register file (HLR), were linked to a switching unit in a variety of ways so as to especially connect the subscriber identification data (IMSI) administered partially differently and the corresponding assigned call numbers (MSISDN).

However, the solutions known to date generally required a special alteration or optionally technical additions to be incorporated in the network for each additional product of a switching unit, whose conversion proved to be extremely costly or which could no longer be realised technically.

It is therefore the object of the present invention to further develop the known communications systems or the known method for operating a communications system such that the usage options for the mobile stations user are further improved. A further object is to minimise technical expenditure with respect to the changes on the network side.

These tasks are solved in technical device terms by the characteristics of claim 1 and in process technology terms by the characteristics of claim 10.

According to the present invention the known communications system is provided with an administrative unit which has an administration data field containing the subscriber identification data (IMSI), the assigned call numbers (MSISDN) and a code field (ID-KORR). This administration data field makes available the relevant basic parameters according to the present invention, on the dealer side for example. With adding only one code field in the switching unit to the GSM-standardised parameters, the transactions on the dealer side are reduced to a minimum. If the inventive communications system also has a fee calculation unit with a fee calculation data field, containing an allocation table, in which the subscriber identification data are linked to the call numbers, then this measure offers an expanded usage possibility for the mobile station user in simple fashion. The result of this linking is that for example a user of a mobile station can be called up via various call numbers and accordingly only one clearing account has to be made available for this. The result is only one account has to be kept for both the switching unit and the user, leading substantially to improved accessibility. In other words, setting a code field for example of a new customer during set-up or during updating of an existing customer signals when the allocation table is activated, so that a preferred service or a special tariff or a special fee can be allocated to the user. The inventive method thus enables another usage option to be implemented inside a network, without the network itself having to be influenced or modified by the basic technical conditions. The inventive method or communications system is in particular an advantage whenever for example systems of a communications system on the dealer side or the input side are not suitable for implementing the allocation table. Furthermore it is an advantage according to the present invention if the linking or a central administration for example takes place in the fee calculation unit which can thus have an indirect influence on the tariffs or fees. With the inventive method or communications system the calculation of fees of the overall system is influenced only when the code field is activated or deactivated.

In this way the inventive method or communications system makes fee calculation fully automatic. This means that setting or activating the code field controls which fee calculation can be made in the fee calculation unit. Based on the automatic mode of operation the expense of carrying out network side modification for introducing the inventive communications system is kept extremely low. As a countermove deactivating of the code field can likewise be employed to simply bring about corresponding modification or reduction of the fee calculation.

Other developments of the communications system or method according to the present invention are specified in the sub-claims.

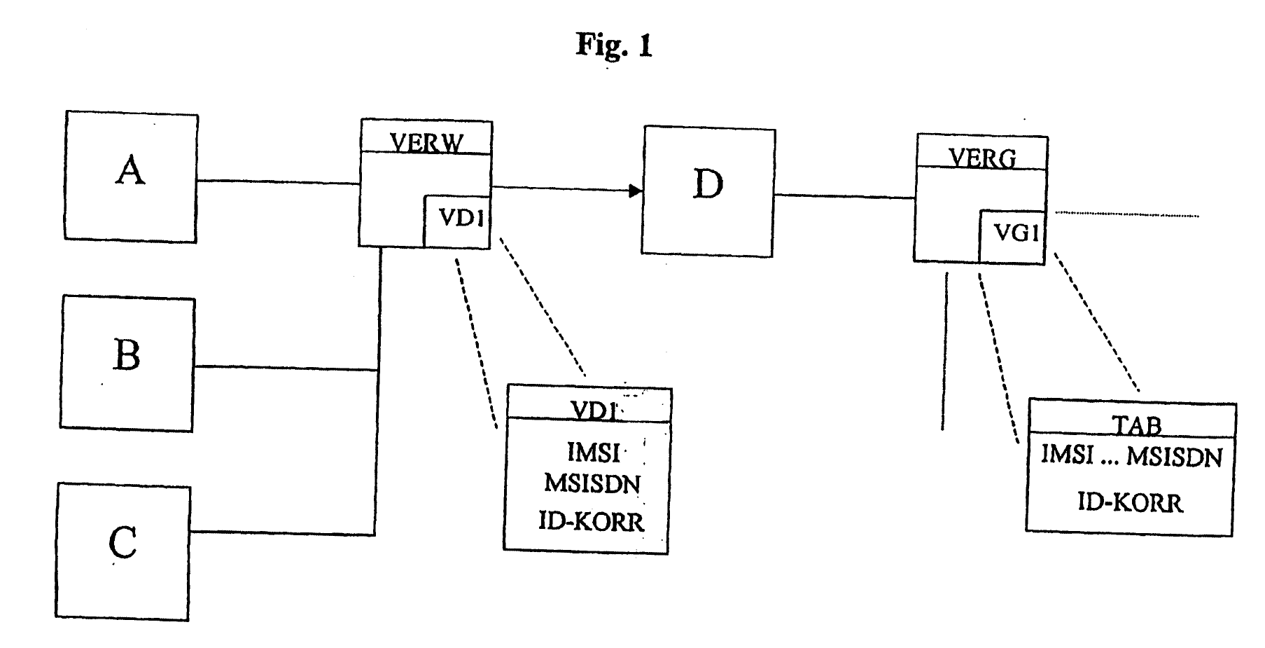

According to the present invention the communications system is used advantageously whenever one or more zone(s) is/are provided for the mobile station, which are defined by combining radio cells. This type of system is described for example in DE 199 11 938 of the applicant, whose disclosure is to be integrated verbatim into the disclosure content of the present application. In particular the disclosure content is integrated with respect to the configuration of the respective zones, i.e. subscriber areas and the different configuration possibilities, described in the exemplary FIGS. 1 to 6 and the associated text sites, into the disclosure content of the present application. The result of activating the code field is that for example two or even more mobile stations, each of which has separate fee calculation according to the multi-radio cell mode to zones, communicate with one another, whereby the respective mobile stations, which for example in each case work according to the known communications system, are connected via the fee calculation unit. By activating or deactivating the code field in the administrative unit and the corresponding allocation table in the fee calculation data field of the fee calculation unit the usage option for the mobile station user can thus be improved on simply and without technical complication. According to DE 199 11 938 the two known communications systems can be interconnected almost fully automatically, without parameter settings specified for this on the network side having to be made manually, insofar as the code field can be activated.

The communications system or method according to the present invention can likewise be used to advantage in mobile stations, each of which has at least one subscriber data module SIM. For this it is necessary only that when the subscriber data module (SIM card) is output the code field is added or activated, and with this the associated subscriber identification data IMSI and corresponding call number MSISDN are linked in the allocation table TAB of the fee calculation unit.

Due to the presence of several subscriber data modules and the corresponding administration in the allocation table there is accordingly the possibility of combining several mobile stations into one group and thus to introduce a special tariff or special fee calculation for the switching unit.

If this type of special fee calculation is provided to the user, then there is intensive stimulus for the user to make connections between two mobile stations, which are subjected to a special tariff due to the communications system according to the present invention.

If the allocation table contains additional inquiry codes, for example to the subscriber identification data (IMSI) and the call numbers (MSISDN), then an improved functional security is provided which ensures the mode of operation of the communications system in simple fashion. In this way further access options are created in each case, without having to work directly in the communications system with the subscriber identification data or call numbers, which is welcome in particular for security considerations. Based on the additional inquiry codes it is also possible to record country-specific identification characteristics, which likewise enable a separate tariff due to matching. If for example an extra data field is added for the activation date, this data field can simply be used to check the affiliation of the utilisation of the particular tariff, and in particular on the basis of activation or deactivation the data field can be used to establish whether the user of the mobile station is considered for special fee calculation apart from the code field.

It has proven an advantage for the code field to be constructed as a five-place integer, via whose value the assignation between the call number and the subscriber identification data can be queried, preferably for fee calculation of different tariffs. It is also possible to optionally control display of the fee calculation tariff in the mobile station (MS) via the code field, with which the user can establish a connection using the allocation table.

It has also proven advantageous if the administration data field displays the direct debiting account of the user belonging to the mobile station, the associated zones with identification information and the details (SIM details) of the subscriber data modules (SIM) belonging to the mobile station, which are adequate for the inventive method or communications system to be able to check to what extent the user is authorised to join the communications system or method according to the present invention or to enjoy the preferred fee calculation.

It is emphasised at this point that if another user should be considered for the inventive communications system or method, then only a main entry has to be made in the administration data field for implementation to be able to take place fully automatically in the fee calculation unit.

In order to ensure that the used mobile stations in particular the respective call numbers with different country-specific call numbers can communicate with one another, or can use the special fee calculation tariff, it is an advantage for the mobile stations to be linked via permutation linking, and in particular permutation linking in which the respective country-specific predial numbers are also listed. This means that it is not necessary to carry out complicated query logics in the background in order to achieve appropriate assignation according to the present invention.

If the allocation table is incorporated in two parts into a first table (TAB1) and in a second table (TAB2), each of the table units or table subunits can be generated in different sections of the overall communications system. It has proven advantageous if generating the first table, which exhibits direct assignation or linking between the subscriber identification data and the corresponding call numbers in the conventional sense, is employed as presetting for generating the second table, which displays the permutation links of the respective subscriber identification data with the respective call numbers. The outcome of this distinction is that only in one unit, preferably the fee calculation unit, can such generating or the associated increase in the quantity of data be positioned optimally inside the overall system.

Advantageous further developments are the subject of the remaining sub-claims.

Embodiments of the inventive object are illustrated with reference to the following diagrams, in which:

FIG. 1 is a block diagram of the mode of operation of the communications system according to the present invention;

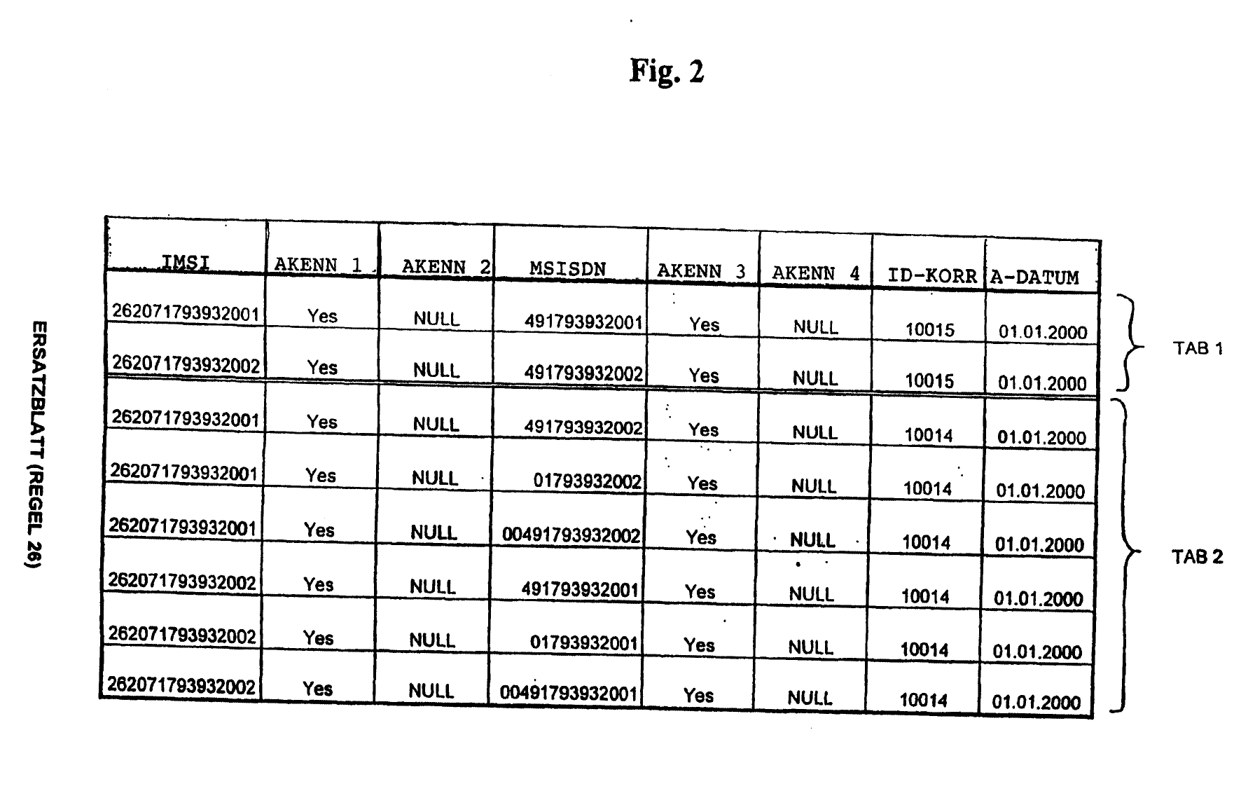

FIG. 2 is an example of an allocation table for communications system according to the present invention.

FIG. 1 illustrates an excerpt of a block diagram to more clearly depict the individual functional units of the communications system according to the present invention. Block diagram A illustrates the position of the dealer connected to the switching unit. This means a new customer is applying to the dealer and signing a contract to utilise the communications system of the switching unit. If desired, the data or parameters for the zones—in terms of DE 199 11 938—can be called up under B. C is generally used to check whether the new customer or the new contract should be accepted or rejected. The data collected in blocks A-C are forwarded optionally with supplementary data to the administrative unit VERW which contains an administration data field VD1, in which the subscriber identification data IMSI, the assigned call number MSISDN and a code field ID-KORR are stored. Usually these collected data of the administrative unit are forwarded to the administrative system of the switching unit (Block D). The administrative system of the switching unit also contains a fee calculation unit VERG, in which the respective fees or connection charges are calculated and debited to the respective user. According to the present invention the fee calculation unit now contains a fee calculation data field, which in turn displays the allocation table TAB, in which the subscriber identification data IMSI are linked to the call numbers MSISDN.

Activating the code data field preset in the administrative unit, which is guided through the administrative system into the fee calculation unit, creates a so-called “corridor”, with which only a small number of parameters is transported or transmitted to the fee calculation unit VERG from the dealer or the administrative unit via the administrative system (Block D) of the switching unit, with which linking can then be carried out between several mobile stations of a user by generating the allocation table TAB only in the fee calculation unit of the switching unit. Based on this diagram illustrated in FIG. 1 it is evident that linking several mobile stations of one or more users can be done fully automatically via the mode of operation described in FIG. 1, without having to implement a technically complicated modification mechanism inside the switching unit.

FIG. 2 shows a possible outline of the allocation table TAB, whereby in this embodiment the allocation table is built in two parts, namely a first table TAB1 for direct assignation or linking and a second table TAB2 for permutation linking between the subscriber identification data IMSI and the respective call numbers MSISDN. FIG. 2 illustrates an eight-column allocation table TAB, with the first column listing the subscriber identification data IMSI for a telecommunications system in this embodiment comprising two mobile stations. The call numbers MSISDN are shown in column 4, with column 7 showing the code field ID-KORR with a five-place integer and column 8 the activation date A Date. If for instance the MSISDN call numbers 491793932001 and 491793932002 assigned to the mobile stations are suitable for the communications system or method according to the present invention, then direct assignation is carried out according to the present invention, i.e. the subscriber identification data IMSI comprising the MCC code equal to 262 and the MMC code 07 along with the MSIN code 1793932001 are linked directly with the corresponding MSISDN, i.e. 0491793932001, whereby the five-place integer equal to 10015 is set for example as code field. The same applies to the IMSI and MSISDN of the second mobile station. These entries accordingly guarantee direct assignation between the subscriber data of the IMSI and the call numbers MSISDN and are generated equal to 10015 based on the identification information field ID-KORR (see TAB 1). The identification information field, which displays the direct link between the respective subscriber identification data IMSI and the corresponding call numbers, can be designated as a so-called main code field, which has to be determined for example only on the dealer side, or on the dealer side the main code field is accordingly activated with a certain trigger.

As shown in FIG. 2, based on the code field optionally activated with a separate trigger further permutation linking is made between both subscriber identification data IMSI and the call numbers MSISDN of both the mobile stations used. For this and in view of the country-specific predial numbers in this embodiment the table TAB 2 is generated in the fee calculation unit VERG. With this linking and based on the presence of the allocation table in the fee calculation unit every telephone call between both the selected mobile stations with an identification code field optionally different to the first code field, in this case a five-place integer equal to 10014, is made such that during connection between both mobile stations a link present in the allocation table TAB, optionally TAB 2, is made, which can then be charged based on matching with a special tariff. Completing the matching can optionally be made dependent on further query codes AKENN 1 to AKENN 4 or on the activation date A Date. To easily configure the assignation logics, the country-specific predial numbers are integrated in the allocation table TAB also, so that there can be unambiguous assignation or matching and thus the administrative technical query mode in the fee calculation unit was reduced to a minimum. Activating and deactivating the communications system according to the present invention can thus be done simply by setting or activating the code field. This means that for deactivating the communications system the code field has only to be updated or deleted. Where another mobile station to be added to the already existing communications system, the subscriber identification data IMSI and the assigned call number MSISDN together with the code field ID-KORR must be made available as main entry only in the administrative unit, which then generates each allocation table TAB, i.e. TAB 1 and/or TAB 2 in the fee calculation unit.

It should be emphasised that through setting the code field for example in the administrative unit the first allocation table TAB 1 is generated and, the result of which is that the second allocation table TAB 2 with the permutation links and optionally with a second code field different to the first code field is generated. The second allocation table TAB 2 is advantageously generated in the fee calculation unit, so that the quantity of data to be managed in the entire system can be likewise kept to a minimum. With the different code fields both a different fee calculation can be undertaken and the code fields can serve as trigger for other functionalities inside the switching units, such as displaying the respective fee calculation tariffs, preferably in the mobile stations (MS).

It is understood that with several mobile stations the allocation table increases in size due to the permutation link. But it is comprehensible that implementing other mobile stations in the communications system according to the present invention can be continued almost randomly, without having a technically large expense inside the switching unit in the process, but nevertheless can be implemented fully automatically.

At this point it is again emphasised that the communications system according to the present invention is particularly advantageously suitable especially in interplay with the communications system according to DE 199 11 938 of the applicant both in the administrative technology sense and on the network side.

1. A communications system comprising at least one mobile station (MS), having a subscriber data module (SIM card) and subscriber identification data (IMSI) deposited thereon and which is supplied by a switching unit (VI) with a corresponding home register file (HLR), in which the call number (MSISDN) assigned to the subscriber identification data (IMSI) is registered, characterised by
an administrative unit (VERW) with a administration data field (VD1) containing the subscriber identification data (IMSI), the assigned call number (MSISDN) and a code field (ID-KORR), and
a fee calculation unit (VERG) with a fee calculation data field (VG1) containing an allocation table (TAB), in which the subscriber identification data (IMSI) are linked to the call numbers (MSISDN).

2. The communications system as claimed in claim 1, whereby for the mobile station (MS) one or more zone(s) is/are provided which are defined by combining radio cells, whereby preferably a fixed network terminal of the switching unit (VI) is employed as basic parameter for the zone.

3. The communications system as claimed in any one of claims 1 or 2, whereby in each case at least one subscriber data module (SIM) is provided for each mobile station (MS).

4. The communications system as claimed in claim 3, whereby the subscriber data modules (SIM) of several mobile stations for the switching unit (VI) are recognisable as a group.

5. The communications system as claimed in claim 3 or 4, whereby the connection between two mobile stations (MS) is subjected to a special tariff.

6. The communications system as claimed in any one of claims 1 to 5, whereby the allocation table (TAB) has additional inquiry codes (AKENN 1, AKENN 2, AKENN 3, AKENN 4) to the subscriber identification data (IMSI) and the call numbers (MSISDN) as well as a data field for the activation date (A-Datum).

7. The communications system as claimed in any one of claims 1 to 6, whereby the code field has a five-place integer which is used in addition for fee calculation.

8. The communications system as claimed in any one of claims 2 to 7, whereby the administration data field contains the account of the user belonging to the mobile station, the assigned zones with identification information and the details (SIM details) of the subscriber data modules (SIM) belonging to the mobile station.

9. The communications system as claimed in any one of claims 1 to 8, whereby the allocation table is incorporated in two parts into a first table (TAB 1) and a second table (TAB 2).

10. A method for operating a communications system, in particular using the communications system as claimed in any one of claims 1 to 9, having the following steps:
a) providing a mobile station (MS) having a subscriber data module (SIM card) and subscriber identification data (IMSI) deposited thereon and which is supplied via a switching unit (VI) with a corresponding home register file (HLR), in which the call number (MSISDN) assigned to the subscriber identification data (IMSI) is registered,
characterised by
b) providing an administrative unit (VERW) with an administration data field (VD1), which contains the subscriber identification data (IMSI), the assigned call number (MSISDN) and a code field (ID-KORR); and
c) linking the subscriber identification data (IMSI) with the call number (MSISDN) by means of an allocation table (TAB)

11. The method as claimed in claim 10, whereby the code field (ID-KORR) determines whether linking takes place, preferably in the fee calculation unit (VERG).

12. The method as claimed in either of claims 10 or 11, whereby at least two mobile stations (MS) are made available which have different subscriber data modules (SIM).

13. The method as claimed in any one of claims 10 to 12, whereby for the mobile station (MS) one or more zone(s) is/are provided which are defined by combining radio cells, whereby preferably a fixed network terminal of the switching unit (VI) is employed as basic parameter of the zone.

14. The method as claimed in any one of claims 10 to 13, whereby the code field (ID-KORR) is a five-place integer, whose significance determines which linking is possible and which is used for fee calculation.

15. The method as claimed in any one of claims 10 to 14, whereby the mobile stations (MS) are linked by permutation linking of the respective subscriber identification data (IMSI) to the respective call numbers (MSISDN), whereby preferably the various country-specific predial numbers are additionally listed with the call number in the allocation table (TAB), in particular for fee calculation.

16. The method as claimed in any one of claims 10 to 15, whereby the allocation table is incorporated in two parts into a first table (TAB 1) and a second table (TAB 2) and
a) via activation of the code field (ID-KORR) the first table generates direct linking between the subscriber identification data (IMSI) and the corresponding call numbers (MSISDN) and
b) after the first table is generated the second table contains the permutation links of the respective subscriber identification data (IMSI) with the respective call numbers (MSISDN).

17. The method as claimed in claim 16, whereby the second table (TAB 2) is generated in the fee calculation unit (VERG).
